(19) United States
(12) Patent Application Publication
(10) Pub. No.: US 2022/0027775 A1
(43) Pub. Date: Jan. 27, 2022

(54) SYMBOLIC MODEL DISCOVERY BASED ON A COMBINATION OF NUMERICAL LEARNING METHODS AND REASONING

(71) Applicant: International Business Machines Corporation, Armonk, NY (US)

(72) Inventors: Cristina Cornelio, Kilchberg (CH); Lior Horesh, North Salem, NY (US); Achille Belly Fokoue-Nkoutche, White Plains, NY (US); Sanjeeb Dash, Croton on Hudson, NY (US)

(21) Appl. No.: 16/934,574

(22) Filed: Jul. 21, 2020

(51) Int. Cl. G06N 20/00; G06N 7/00

(52) U.S. Cl. CPC G06N 20/00; G06N 7/00

(57) ABSTRACT

Aspects of the invention include obtaining a set of data that includes inputs and outputs to be modelled and performing a symbolic regression to find a symbolic model that fits the inputs and the outputs of the set of data. The symbolic model is a symbolic expression discovered by the symbolic regression in a search space. Automated reasoning is performed to affect a final symbolic model that is used to obtain new outputs from new inputs based on the final symbolic model.

### STATEMENT REGARDING FEDERALLY SPONSORED RESEARCH OR DEVELOPMENT

This invention was made with Government support under Agreement No. HR0011-19-9-0041, awarded by DARPA. The Government has certain rights in the invention.

### BACKGROUND

The present invention generally relates to programmable computers and, more specifically, to programmable computer systems configured and arranged to perform symbolic model discovery based on a combination of numerical learning methods and reasoning.

A symbolic model is a symbolic expression involving a number of unknown quantities or variables. By automatically discovering a symbolic model that fits inputs and outputs of a training dataset or collected data, the symbolic model can then be used to predict (i.e., compute) an output when only inputs are collected or measurable. Prior approaches to discovering a symbolic model include symbolic regression. Symbolic regression refers to a type of regression analysis that searches the space of mathematical expressions to find a symbolic model that provides a close fit to output of a dataset given the input of that dataset. The symbolic model is inferred from the data and the model structures and model parameters are discovered. A drawback of using symbolic regression alone to obtain a symbolic model is the time it can take to converge on the optimal symbolic expression.

### SUMMARY

Embodiments of the present invention are directed to symbolic model discovery based on a combination of numerical learning methods and reasoning. A non-limiting example computer-implemented method includes obtaining a set of data that includes inputs and outputs to be modelled and performing a symbolic regression to find a symbolic model that fits the inputs and the outputs of the set of data. The symbolic model is a symbolic expression discovered by the symbolic regression in a search space. Automated reasoning is performed to affect a final symbolic model that is used to obtain new outputs from new inputs based on the final symbolic model.

In some of the above-described embodiments, performing automated reasoning before the symbolic regression includes imposing additional constraints on the symbolic regression based on the automated reasoning.

In some of the above-described embodiments, symbolic regression and automated reasoning are performed iteratively until the symbolic model generated by the symbolic regression is consistent with a proof generated by the automated reasoning.

In some of the above-identified embodiments, automated reasoning is performed along with the symbolic regression and the symbolic regression uses a reasoning engine to generate the symbolic model.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 shows the process flow of a method of obtaining output using a symbolic model discovery based on a combination of numerical learning methods and reasoning according to one or more embodiments of the invention;

FIG. 2 is a process flow of an exemplary method of obtaining a symbolic model based on a combination of numerical learning methods and reasoning according to one or more embodiments of the invention;

FIG. 3 is a process flow of an exemplary method of obtaining a symbolic model based on a combination of numerical learning methods and reasoning according to one or more embodiments of the invention;

FIG. 4 is a process flow of an exemplary method of obtaining a symbolic model based on a combination of numerical learning methods and reasoning according to one or more embodiments of the invention; and

FIG. 5 is a block diagram of a processing system for obtaining a symbolic model based on a combination of numerical learning methods and reasoning according to one or more embodiments of the invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

Embodiments of the invention provide systems and methods configured and arranged to perform symbolic model discovery based on a combination of numerical learning methods and automated reasoning. Automated reasoning involves a computing system being given a set of assumptions (or axioms) and a goal and using logical inferences to reach the goal. Examples of systems that perform automated reasoning include KeYmaera® for dynamic-differentiable-logic or Vampire for first-order-logic with equality. Automated reasoning can be used to develop a proof (i.e., the logical inferences) given background theory such as a set of known axioms (i.e., the set of assumptions) and a symbolic model (i.e., the goal).

According to one or more embodiments of the invention, the symbolic model discovered via numerical learning methods (i.e., symbolic regression) is enhanced in some way with reasoning according to exemplary embodiments of the invention that are detailed herein. The numerical learning methods and automated reasoning are implemented as machine learning in one or more embodiments of the invention. According to one exemplary embodiment of the invention, reasoning based verification is used on the symbolic model discovered via symbolic regression. This discovery and verification process may be iterative. According to another exemplary embodiment of the invention, reasoning may be used to influence the symbolic regression rather than to verify its result. For example, reasoning may be used to impose additional constraints on the symbolic regression. In yet another exemplary embodiment of the invention, the symbolic regression and reasoning may be used together to discover a symbolic model. Based on enhancement of the symbolic regression through the automated reasoning, faster convergence on the optimal symbolic expression is achieved as compared to using symbolic regression alone.

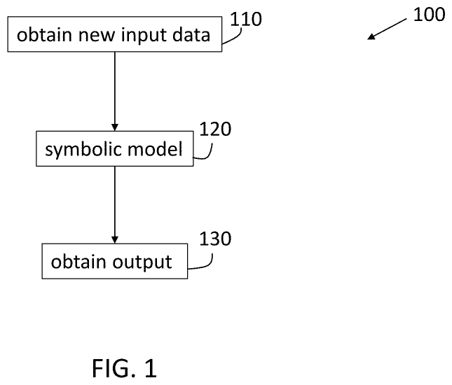

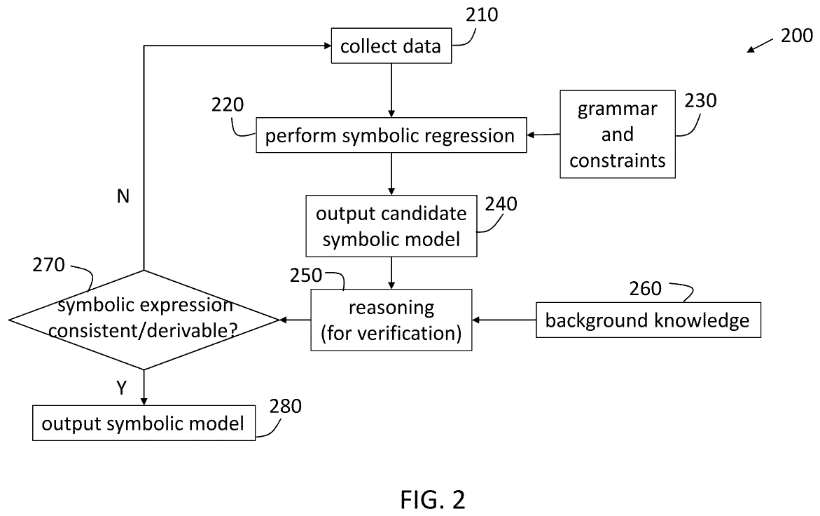

FIG. 1 shows the process flow of a method 100 of obtaining output using a symbolic model discovery based on a combination of numerical learning methods and reasoning according to one or more embodiments of the invention. Exemplary embodiments of obtaining the symbolic model are detailed with reference to FIGS. 2-5. Once the symbolic model is obtained, it may be employed as shown in FIG. 1. At block 110, the process flow includes obtaining new input data 110. At block 120, using the symbolic model on the new input data results in obtaining output, at block 130. For example, the symbolic model may be a symbolic expression for orbital speed of a satellite. This symbolic model may be obtained according to one of the exemplary embodiments of the invention that is discussed with reference to FIGS. 2-5. The data used to discover the symbolic model includes both inputs (e.g., radius of orbit of a satellite) and the output (i.e., orbital speed). Once this symbolic model is obtained, new input (e.g., radius of orbit of another satellite whose orbital speed is not known) may be obtained (at block 110) and used with the symbolic model (at block 120) to obtain, at block 130, the output (i.e., orbital speed of the other satellite).

FIG. 2 is a process flow of an exemplary method 200 of obtaining a symbolic model based on a combination of numerical learning methods and reasoning according to one or more embodiments of the invention. At block 210, collecting data can include designing an experiment to generate input and output data of interest or collecting or measuring data in a non-experimental setting. Performing symbolic regression, at block 220, is based on grammar and other constraints provided at block 230. Grammar refers to the established rules that govern how a symbolic expression may be built. For example, a sum requires two inputs that are added and a single “+.” Constraints impose rules on symbolic expressions. Constraints include established invariances that apply to all symbolic expressions. For example, the commutative property that specifies that “A+B” is equivalent to “B+A” is an invariant. The invariants prevent the redundant generation of multiple candidate symbolic expressions that are actually equivalent. Constraints can also include other, application-specific rules. These constraints capture specific knowledge about the application. For example, when one particular input is 0, the symbolic expression output may be required to be 0 for a given exemplary application.

At block 220, performing symbolic regression using the grammar and constraints specified at block 230 results in outputting a candidate symbolic model at block 240. Symbolic regression is a known technique for the derivation of symbolic expressions from numerical data. The technique may involve formulating a global optimization problem, such as mixed-integer nonlinear programming, that can be solved with known software. According to a prior approach, this symbolic model may be used in the process flow of the method 100 shown in FIG. 1. But, according to an exemplary embodiment of the invention, the method 200 includes performing reasoning at block 250 to verify the candidate symbolic model output at block 240. As previously noted, given a set of assumptions and a goal, automated reasoning uses logical inferences to try to reach the goal and, thereby, establish a proof.

At block 250, the reasoning uses background knowledge from block 260 as the set of assumptions and the candidate symbolic model at block 240 as the goal. The background knowledge at block 260 may be axioms specific to the application. In the exemplary case of the application being the determination of a symbolic expression for orbital speed of a satellite, the background knowledge may include formulas defining gravitational force and kinetic force, as well as the knowledge that the two are equal at equilibrium. This knowledge may be the starting point of the derivation undertaken as part of the reasoning to reach the candidate symbolic model at block 240 as the goal.

At block 270, a check is done of whether a proof derived by the reasoning at block 250 is consistent with the candidate symbolic model at block 240. That is, a determination is made of whether the symbolic expression output as the candidate symbolic model at block 240 is derivable by the reasoning at block 250 using the background knowledge at block 260. If so, the candidate symbolic model is output, at block 280, as the symbolic model to be used in the method 100 shown in FIG. 1. If the check at block 270 indicates that the reasoning at block 250 did not find consistency between the proof and the candidate symbolic model at block 240 using the background knowledge from block 260, then another iteration is undertaken. More data may be collected through experimentation or measurement, at block 210, to start the next iteration. As FIG. 2 indicates, the processes are performed iteratively until the symbolic model determined via symbolic regression, at block 220, is proven with reasoning, at block 250. Convergence is enhanced and expedited, according to this exemplary embodiment of the invention, by ensuring that an inconsistent symbolic model is corrected immediately.

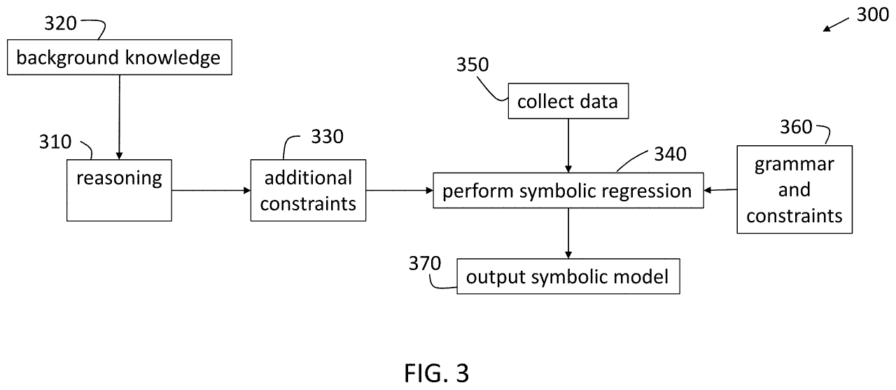

FIG. 3 is a process flow of an exemplary method 300 of obtaining a symbolic model based on a combination of numerical learning methods and reasoning according to one or more embodiments of the invention. According to exemplary embodiments of the invention, reasoning is used to influence the operation of the symbolic regression rather than to verify the result of the symbolic regression. As detailed, reasoning is used to impose additional constraints on the symbolic regression. Thus, according to this exemplary embodiment of the invention, convergence is enhanced and expedited by affecting the discovery of the symbolic model using the symbolic regression. At block 310, reasoning is performed. Background knowledge from block 320 is used by the reasoning, at block 310, to generate additional constraints at block 330.

According to an exemplary embodiment of the invention, the additional constraints are similar to the application-specific constraints at block 360 which, along with grammar and invariances, affect the symbolic regression at block 340. Exemplary additional constraints generated at block 330 include a condition on a derivative or integral of the formula (i.e., symbolic model) in a specified interval. This symbolic regression at block 340 also uses data collected at block 350 through experimentation or measurements. At block 340, performing symbolic regression is based on the data from block 350, grammar and constraints from block 360, and the additional constraints at block 330 that are generated by the reasoning, at block 310. This symbolic regression at block 340 results in outputting a symbolic model, at block 370, for use in the method 100 at FIG. 1.

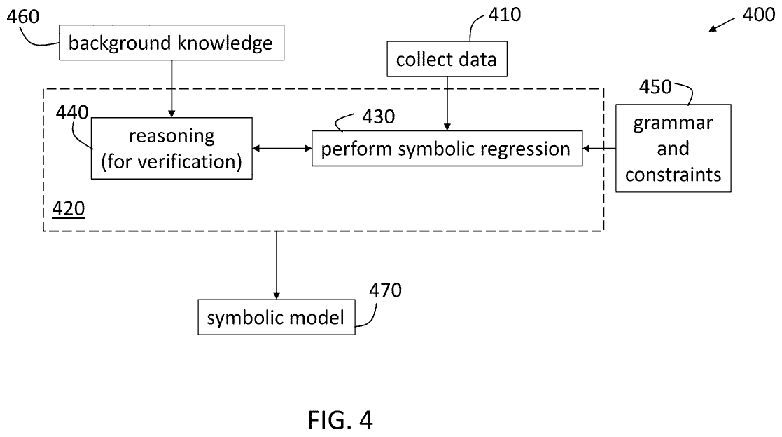

FIG. 4 is a process flow of an exemplary method 400 of obtaining a symbolic model based on a combination of numerical learning methods and reasoning according to one or more embodiments of the invention. According to the exemplary embodiment of the invention, a symbolic model discovery module 420 involves both symbolic regression, at block 430, and reasoning, at block 440. Unlike the embodiment discussed with reference to FIG. 2, which includes an iterative process of performing symbolic regression (at block 220) and verifying the result using reasoning (at block 250), the symbolic regression at block 430 and the reasoning at block 440 are used together to discover the symbolic model in a non-iterative process. For example, a genetic algorithm may be used for the symbolic regression at block 430.

In a standard genetic approach to symbolic regression, an initial formula is generated randomly and, at each step of the symbolic regression process, the formula is expanded with a random expansion. According to the exemplary embodiment using the symbolic model discovery module 420, the expansion is performed in a principled way rather than randomly. Formulas in the background knowledge 460 are used, by the reasoning at block 440, to expand the initial formula generated by the symbolic regression at block 430. The symbolic regression at block 430 may use collected data (i.e., experimental data or measured data) from block 410 and grammar and constraints at block 450. The final symbolic model that is output by the symbolic model discovery module 420 is consistent and provable from the background knowledge at block 460. Then, the symbolic model discovery module 420 outputs this final symbolic model, at block 470, for use in the method 100 shown in FIG. 1. Convergence is enhanced and expedited, according to this exemplary embodiment of the invention, by guiding the symbolic model that is discovered by the symbolic regression.

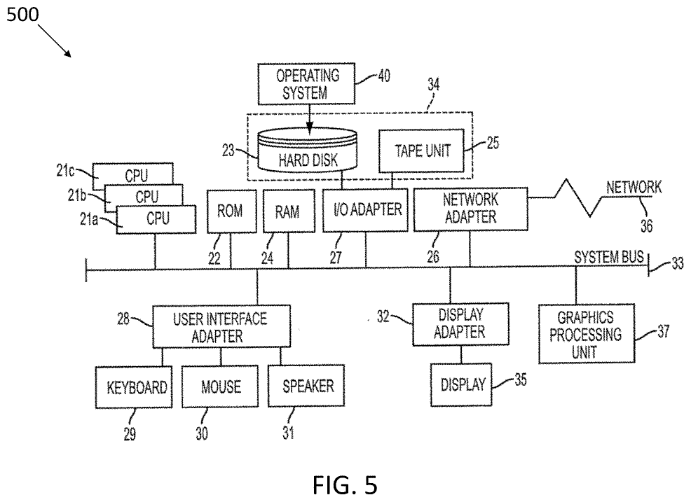

It is understood that one or more embodiments of the present invention are capable of being implemented in conjunction with any other type of computing environment now known or later developed. For example, FIG. 5 depicts a block diagram of a processing system 500 for implementing the techniques described herein (e.g., processes of the methods 100-400). In the embodiment shown in FIG. 5, processing system 500 has one or more central processing units (processors) 21a, 21b, 21c, etc. (collectively or generically referred to as processor(s) 21 and/or as processing device(s)). According to one or more embodiments of the present invention, each processor 21 can include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and can include a basic input/output system (BIOS), which controls certain basic functions of processing system 500.

Further illustrated are an input/output (I/O) adapter 27 and a communications adapter 26 coupled to system bus 33. I/O adapter 27 can be a small computer system interface (SCSI) adapter that communicates with a hard disk 23 and/or a tape storage drive 25 or any other similar component. I/O adapter 27, hard disk 23, and tape storage device 25 are collectively referred to herein as mass storage 34. Operating system 40 for execution on processing system 500 can be stored in mass storage 34. The RAM 22, ROM 24, and mass storage 34 are examples of memory 19 of the processing system 500. A network adapter 26 interconnects system bus 33 with an outside network 36 enabling the processing system 500 to communicate with other such systems.

A display (e.g., a display monitor) 35 is connected to system bus 33 by display adaptor 32, which can include a graphics adapter to improve the performance of graphics intensive applications and a video controller. According to one or more embodiments of the present invention, adapters 26, 27, and/or 32 can be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 can be interconnected to system bus 33 via user interface adapter 28, which can include, for example, a Super I/O chip integrating multiple device adapters into a single integrated circuit.

According to one or more embodiments of the present invention, processing system 500 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing and has a highly parallel structure that makes it more effective than general-purpose CPUs for algorithms where processing of large blocks of data is done in parallel.

Thus, as configured herein, processing system 500 includes processing capability in the form of processors 21, storage capability including system memory (e.g., RAM 24), and mass storage 34, input means such as keyboard 29 and mouse 30, and output capability including speaker 31 and display 35. According to one or more embodiments of the present invention, a portion of system memory (e.g., RAM 24) and mass storage 34 collectively store an operating system such as the AIX® operating system from IBM Corporation to coordinate the functions of the various components shown in processing system 500.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
obtaining a set of data that includes inputs and outputs to be modelled;
performing a symbolic regression to find a symbolic model that fits the inputs and the outputs of the set of data, wherein the symbolic model is a symbolic expression discovered by the symbolic regression in a search space; and
performing automated reasoning to affect a final symbolic model that is used to obtain new outputs from new inputs based on the final symbolic model.

2. The computer-implemented method according to claim 1, wherein the obtaining the set of data is based on designing an experiment to generate the set of data or on measuring the set of data.

3. The computer-implemented method according to claim 1, wherein the performing the symbolic regression includes obtaining grammar and constraints, the grammar indicating rules that govern how the symbolic expression may be built and the constraints impose general and application-specific rules on the symbolic expression.

4. The computer-implemented method according to claim 3, wherein the performing the automated reasoning before the symbolic regression includes imposing additional constraints on the symbolic regression based on the automated reasoning.

5. The computer-implemented method according to claim 1, wherein the performing the automated reasoning is after the symbolic regression.

6. The computer-implemented method according to claim 5, further comprising iteratively performing the symbolic regression and the automated reasoning until the symbolic model generated by the symbolic regression is consistent with a proof generated by the automated reasoning.

7. The computer-implemented method according to claim 1, wherein the automated reasoning is performed along with the symbolic regression and includes a process of the symbolic regression using a reasoning engine to generate the symbolic model.

8. A system comprising:
a memory having computer readable instructions; and
one or more processors for executing the computer readable instructions, the computer readable instructions controlling the one or more processors to perform operations comprising:
obtaining a set of data that includes inputs and outputs to be modelled;
performing a symbolic regression to find a symbolic model that fits the inputs and the outputs of the set of data, wherein the symbolic model is a symbolic expression discovered by the symbolic regression in a search space; and
performing automated reasoning to affect a final symbolic model that is used to obtain new outputs from new inputs based on the final symbolic model.

9. The system according to claim 8, wherein the obtaining the set of data is based on designing an experiment to generate the set of data or on measuring the set of data.

10. The system according to claim 8, wherein the performing the symbolic regression includes obtaining grammar and constraints, the grammar indicating rules that govern how the symbolic expression may be built and the constraints impose general and application-specific rules on the symbolic expression.

11. The system according to claim 10, wherein the performing the automated reasoning before the symbolic regression includes imposing additional constraints on the symbolic regression based on the automated reasoning.

12. The system according to claim 8, wherein the performing the automated reasoning is after the symbolic regression.

13. The system according to claim 12, further comprising iteratively performing the symbolic regression and the automated reasoning until the symbolic model generated by the symbolic regression is consistent with a proof generated by the automated reasoning.

14. The system according to claim 8, wherein the automated reasoning is performed along with the symbolic regression and includes a process of the symbolic regression using a reasoning engine to generate the symbolic model.

15. A computer program product comprising a computer readable storage medium having program instructions embodied therewith, the program instructions executable by a processor to cause the processor to perform operations comprising:
obtaining a set of data that includes inputs and outputs to be modelled;
performing a symbolic regression to find a symbolic model that fits the inputs and the outputs of the set of data, wherein the symbolic model is a symbolic expression discovered by the symbolic regression in a search space; and
performing automated reasoning to affect a final symbolic model that is used to obtain new outputs from new inputs based on the final symbolic model.

16. The computer program product according to claim 15, wherein the obtaining the set of data is based on designing an experiment to generate the set of data or on measuring the set of data.

17. The computer program product according to claim 15, wherein the performing the symbolic regression includes obtaining grammar and constraints, the grammar indicating rules that govern how the symbolic expression may be built and the constraints impose general and application-specific rules on the symbolic expression, and the performing the automated reasoning before the symbolic regression includes imposing additional constraints on the symbolic regression based on the automated reasoning.

18. The computer program product according to claim 15, wherein the performing the automated reasoning is after the symbolic regression.

19. The computer program product according to claim 18, further comprising iteratively performing the symbolic regression and the automated reasoning until the symbolic model generated by the symbolic regression is consistent with a proof generated by the automated reasoning.

20. The computer program product according to claim 15, wherein the automated reasoning is performed along with the symbolic regression and includes a process of the symbolic regression using a reasoning engine to generate the symbolic model.
